(19) United States
(12) Patent Application Publication
(10) Pub. No.: US 2009/0276625 A1
(43) Pub. Date: Nov. 5, 2009

(54) HIERARCHICAL BROWSING MANAGEMENT METHOD AND SYSTEM FOR DIGITAL CONTENT

(75) Inventors: Shih-I HUANG, Taichung City (TW); Po-Yuan TENG, Kaohsiung City (TW)

Correspondence Address: Workman Nydegger;1000 Eagle Gate Tower, 60 East South Temple, Salt Lake City, UT, 84111, US

(73) Assignee: INDUSTRIAL TECHNOLOGY RESEARCH INSTITUTE, Hsinchu (TW)

(21) Appl. No.: 12/256,122

(22) Filed: Oct. 22, 2008

(30) Foreign Application Priority Data
May 2, 2008 (TW) 097119781

(51) Int. Cl. H04L 9/00; H04L 9/06

(52) U.S. Cl. 713/168; 380/277

(57) ABSTRACT

A hierarchical browsing management method and system for a digital content are described, in which a client decrypts a part of an encrypted content corresponding to an user permission of the client according to a different decryption key. The hierarchical browsing management method includes the following steps. A document fetching unit fetches a digital content, and then loads and stores the digital content to a document server. A client sends a request for transferring the digital content to another client to the document server. A key server executes a content encryption procedure, assigns a corresponding user permission to each content object, and generates encrypted objects. The content encryption procedure is executed to generate encrypted objects and a corresponding encrypted content according to the corresponding user permission assigned to each content object. The client receives the encrypted content, executes a decryption procedure for the encrypted objects, and outputs a decrypted content.

### CROSS-REFERENCE TO RELATED APPLICATIONS

This non-provisional application claims priority under 35 U.S.C. § 119(a) on Patent Application No(s). 097119781 filed in Taiwan, R.O.C. on May 5, 2008 the entire contents of which are hereby incorporated by reference.

### BACKGROUND OF THE INVENTION

1. Field of the Invention

The present invention relates to a method and a system for document browsing management, in particular, to a hierarchical browsing management method and system for a digital document.

2. Related Art

Along with the rapid development of information technology, more and more information needs to be exchanged accordingly. In order to ensure that the information to be sent is only browsed by an appropriate receiver, two encryption manners are often adopted, namely, symmetric key encryption, and asymmetric key encryption.

The symmetric key encryption is to encrypt/decrypt with the same key. In other words, a server encrypts/decrypts information through using the same set of passwords. The symmetric key encryption has the advantages that the encryption/decryption motion is relatively fast and does not cause a heavy load of a system. Therefore, both parties may encrypt and decrypt the information under transmission with the same symmetric key. The asymmetric key encryption adopts two different keys, one is a public key, and the other is a private key, i.e., the public key is public, but the private key is confidential.

Based on the aforementioned encryption manners, a hierarchical management system is further proposed. In the conventional hierarchical management system, information is exchanged and transferred by using the above encryption manners based on user permissions of users. FIG. 1 is a flow chart of operations of a conventional hierarchical management system. Firstly, a transmitter sets a lowest interpretation authority of a transmitted digital content (Step S110). Next, an encryption procedure is executed (Step S120), so as to generate a corresponding encrypted content. Then, the encrypted content is transmitted (Step S130). It is determined whether an user permission of a receiver satisfies the interpretation authority of the encrypted content or not (Step S140), and if yes, the receiver executes a decryption procedure and transmits a decryption result to another receiver with a subordinate user permission (Step S141). Steps S130-S140 are repeated till an user permission of a current receiver just satisfies the lowest interpretation authority set for the digital content.

In the conventional hierarchical management system, a user of the subordinate level cannot begin a corresponding decryption motion unless a user of the superordinate level executes the decryption procedure and transmits the decryption result to the user of the subordinate level. As a result, each user in a system must rely on other users to read the received content, thereby prolonging the time for receiving the document by the whole system. Furthermore, in the conventional hierarchical management system, the users in the same group may read the same contents, which easily results in inside attacks, thereby possibly causing severe damages to the conventional hierarchical management system.

### SUMMARY OF THE INVENTION

The present invention is directed to a hierarchical browsing management method for a digital content, in which different decryption keys are used to browse different parts of content data in the digital content corresponding to different user permissions thereof.

A hierarchical browsing management method for a digital content is provided in the present invention, which includes the following steps: loading a digital content; executing a content encryption procedure to assign a corresponding user permission to each content object, so as to generate encrypted objects; according to a sequence of the user permissions, executing the content encryption procedure on the content objects in the digital content, so as to generate encrypted objects; recording the encrypted objects and generating a corresponding encrypted content respectively according to the sequence of the user permissions; receiving the encrypted content; according to user permissions of decryption keys, executing a decryption procedure on the encrypted objects in the encrypted content, and outputting parts of the digital content corresponding to the user permissions of the decryption keys.

The present invention is further directed to a hierarchical management system for a digital content, in which different decryption keys are used to browse different parts of content data in the digital content corresponding to different user permissions thereof.

A hierarchical browsing management system is provided in the present invention, which includes: a plurality of clients; a plurality of document fetching units, for fetching a plurality of digital documents; at least one document server, electrically connected to the document fetching units and the clients, for storing digital documents fetched by the document fetching units and executing an object fetching procedure on the digital documents to fetch a plurality of content objects; and at least one key server, electrically connected to the document server and the clients, for executing a content encryption procedure on the content objects according to different user permissions, generating an encrypted content according to the digital documents and the content objects, and storing the encrypted content in the document server. When a client sends out a document query request to the document server, the key server determines a corresponding user permission of the client, so that the document server submits the corresponding encrypted content to the client according to the user permission of the client.

The hierarchical browsing management method and system for a digital content according to the present invention enable users with a higher authority to browse all content objects below his/her authority and prevent users with a lower authority from browsing content objects inconsistent with his/her authority. In this way, according to different user permissions, each user browses the digital content consistent with the user permission.

### BRIEF DESCRIPTION OF THE DRAWINGS

The present invention will become more fully understood from the detailed description given herein below for illustration only, and thus is not limitative of the present invention, and wherein:

FIG. 1 is an architectural schematic view of the prior invention;

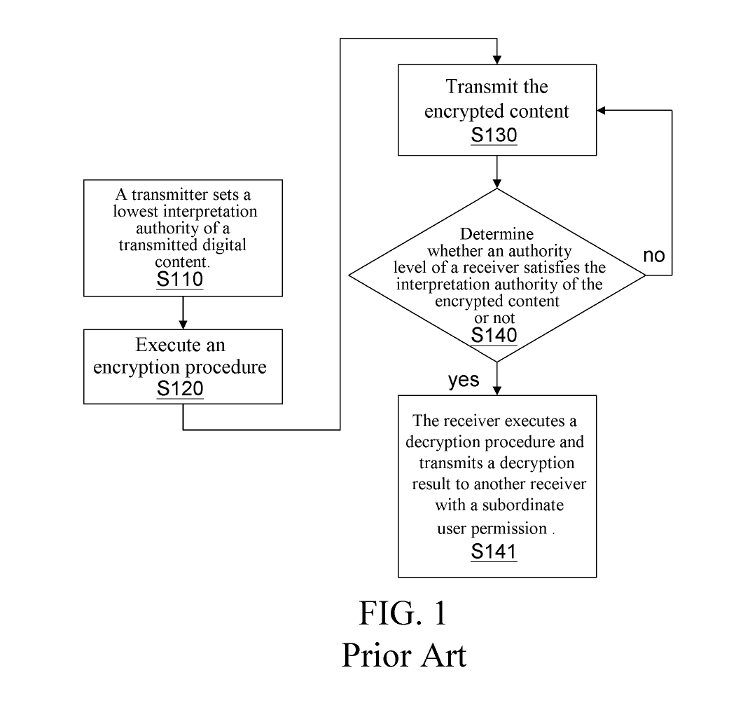

FIG. 2a is an architectural schematic view of a hierarchical browsing management system according to the present invention;

FIG. 2b is an architectural schematic view of a plurality of key servers and document servers;

FIG. 3 is a schematic flow chart of a hierarchical browsing management method according to the present invention;

FIG. 4a is a schematic view of a captured digital image;

FIG. 4b is a schematic view of content objects in the digital image;

FIG. 4c is a schematic view of an encrypted digital content; and

FIG. 4d is a schematic view of encrypted objects in the digital content.

### DETAILED DESCRIPTION OF THE INVENTION

The present invention provides a hierarchical browsing management method and system for a digital content, in which different decryption keys are used to browse different parts of content data in the digital content corresponding to different user permissions thereof. The digital content in the present invention may be a digital document file, a digital image file, or a digital video file. The digital content includes a plurality of content objects. For example, if the digital content is a digital image file, the content objects are image objects; and if the digital content is a digital text file, the content objects are characters or words.

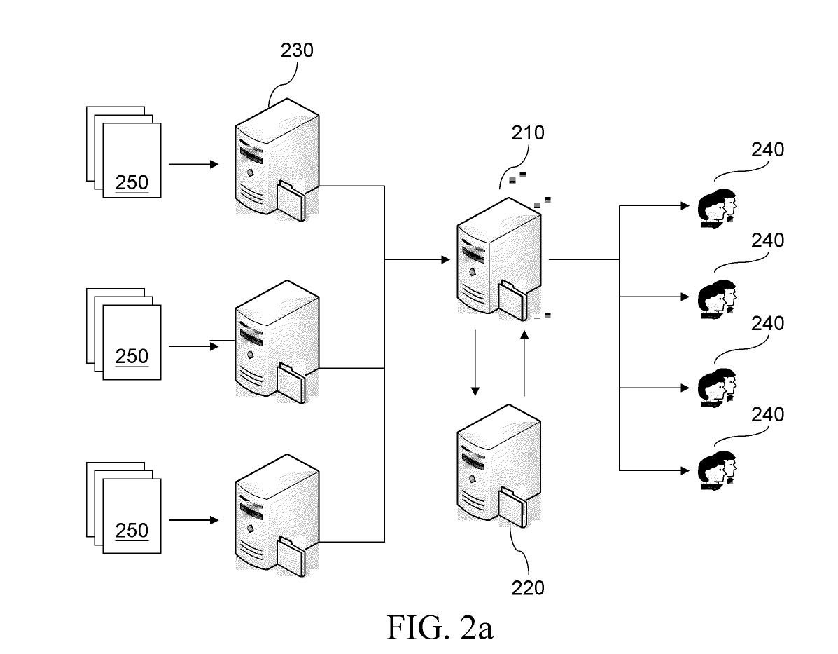

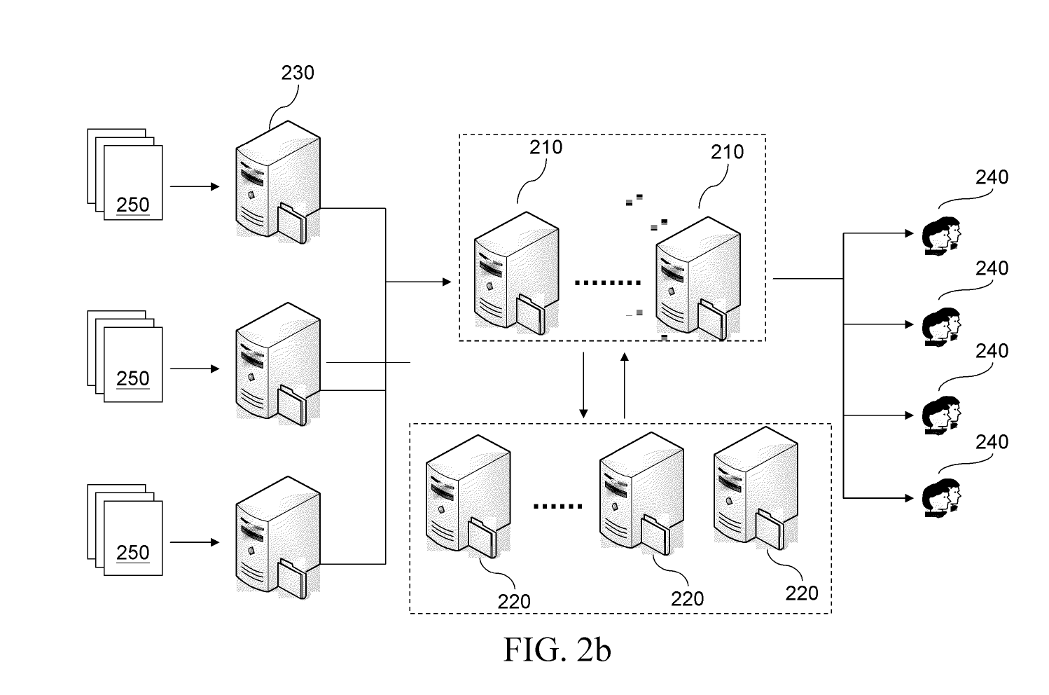

FIG. 2a is an architectural schematic view of a hierarchical browsing management system according to the present invention. The hierarchical browsing management system in the present invention includes a document server 210, a key server 220, document fetching units 230, and clients 240.

Every user of the clients 240 is allocated with a decryption key corresponding to an user permission thereof. In addition, a plurality of clients 240 may be considered as a group, which is assigned with a corresponding user permission. Each of the document fetching units 230 is used to fetch a plurality of digital documents (i.e., digital contents) 250. In this implementation aspect, a digital image file is taken as an example, but the present invention is not limited herein.

The document server 210 is electrically connected to the document fetching units 230 and the clients 240. The document server 210 is used for storing digital documents 250 fetched by the document fetching units 230, and executes an object fetching procedure on the digital documents 250, so as to fetch a plurality of content objects from the digital contents. For example, if one digital image is formed by a plurality of image objects, the image objects are respectively fetched.

The key server 220 is electrically connected to the document server 210 and the clients 240. The key server 220 executes a content encryption procedure on the content objects respectively according to each user permission, so as to generate an encrypted content corresponding to each user permission. Then, the key server 220 transmits the encrypted content back to the document server 210 for being stored therein. When the client 240 sends out a document query request to the document server 210, the key server 220 determines a corresponding user permission of the client 240, and instructs the document server 210 to submit the corresponding encrypted content to the client 240.

In addition to the key server 220 and the document server 210 in FIG. 2a, the key server 220 and the document server 210 may be further disposed in a plurality of computer devices. FIG. 2b is an architectural schematic view of a plurality of key servers and document servers. Each server may exchange keys or documents with one another over Internet or through other connection manners.

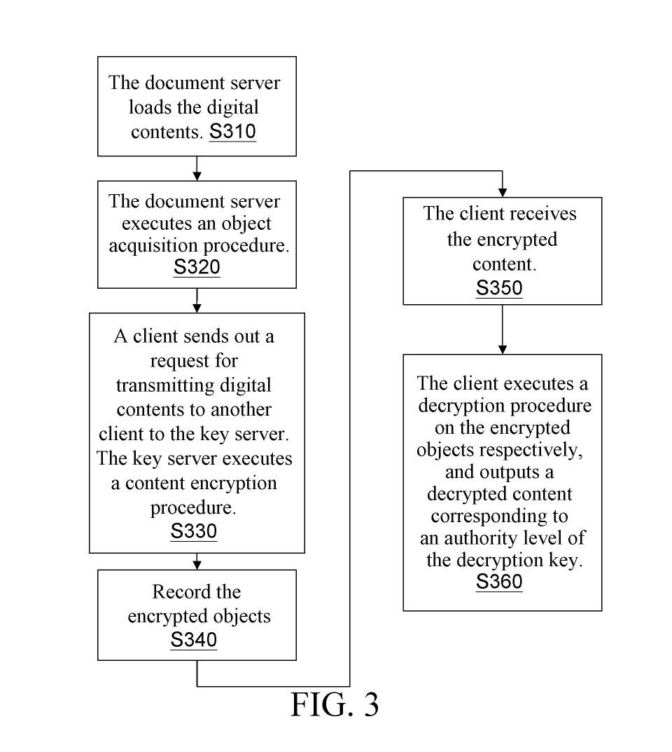

FIG. 3 is a schematic flow chart of a hierarchical browsing management method according to the present invention. The hierarchical browsing management method includes the following steps. The document fetching units 230 fetch a plurality of digital contents. The document server loads the digital contents (Step S310). The document server executes an object fetching procedure (Step S320), so as to fetch a plurality of content objects. A client sends out a request for transmitting digital contents to another client to the key server. The key server executes a content encryption procedure (Step S330), so as to assign a corresponding user permission to each content object, so as to generate encrypted objects. The encrypted objects are recorded (Step S340), and a corresponding encrypted content is generated according to the sequence of the user permissions. The client receives the encrypted content (Step S350). The client executes a decryption procedure on the encrypted objects, and outputs a decrypted content corresponding to an user permission of the decryption key (Step S360). It should be noted that, the present invention may further output a corresponding digital content for the encrypted objects with user permissions lower than the user permission of the decryption key according to the user permission of the decryption key.

The content encryption procedure may be realized by a symmetric key encryption or an asymmetric key encryption. The symmetric key encryption in the present invention may be data encryption standard (DES), IDEA, RC2, RC4, or other symmetric key encryption manners with the same function. The asymmetric key encryption may be RSA, digital signature algorithm (DSA), Diffie-Hallman, or other asymmetric key encryption manners with the same function. In order to understand the operation flows of different encryption manners in the present invention comprehensively, the following implementation aspects are proposed and explained. The following terms and definitions are provided as a reference.
A={A₁, A₂, . . . , Aₚ} represents a user of an decryption key with P control user permissions, and in this implementation aspect, Aᵢ<Aⱼ, which represents the user permission of Aᵢ is higher than the security level of Aⱼ.
Digital content M={M₁, M₂, . . . , Mₚ}, Mₜ represents a content object that may be accessed by the decryption key with the control authority Aₜ.
Group key K={K₁, K₂, . . . , Kₚ}, Kₜ is a key possessed by decryption keys with the control authority Aₜ.

Image encryption key IK={IK₁, IK₂, . . . , IKₚ}, IKₜ is used to encrypt the content object Mₜ.
User ID: IDₘ∈{0,1}*, in which IDₙ≠IDₘ, ∀n≠m
One-way hash function H: {0,1}ⁿ→{0,1}
One-way hash function H₁:{0,1}*→G₁*
One-way hash function H₂:G₂→{0,1}ⁿ, in which n represents a length of a string to be encrypted.
One-way hash function H₃:Z_{P}*→Zₚ*.
Encryption function: E( ).

Decryption function: D( ).
Additive Group: G₁.
Multiplicative group: G₂; G₁, and G₂ are the same order q and e: G₁×G₁→G₂, e(aP,bQ)^{ab}∀P,Q∈G₁.

a. Symmetric Key Encryption

Firstly, each document fetching unit 230 fetches digital contents M and then stores them in the document server 210. The document server 210 executes an object fetching procedure on the digital content M, so as to fetch a plurality of content objects Mₜ, M={M₁, M₂, . . . , Mₚ}, t∈{1 . . . , p}.

The key server 220 respectively generates a corresponding object encryption key IK₁ according to each content object, and IK₁={0,1}ⁿ. Then, object encryption keys at subordinate user permissions are generated by means of a hash key chain, which are represented as {IK₂, . . . , IKₚ}, in which IKₜ=H^{t-1} (IK₁), and t∈{2 . . . p}.

The key server 220 executes a content encryption procedure. The key server 220 respectively encrypts the content objects Mₜ with corresponding object encryption keys IKₜ, so as to generate encrypted content objects E_{IK}_{ₜ} (Mₜ), in which t∈{2 . . . p}. Then, the group encryption key Kₜ is used to encrypt each corresponding object encryption key IKₜ, thereby generating each corresponding encrypted group object Eₖ_{ₜ} (IKₜ). The encrypted group object Eₖ_{ₜ} (IKₜ) and the encrypted content object E_{IK}_{ₜ} (Mₜ) are combined, thereby finally generating an encrypted message E_{IK}_{ₜ} (Mₜ)∥Eₖ_{ₜ} (IKₜ).

When the client 240 sends out a document query request to the document server 210, the key server 220 executes a decryption procedure on the encrypted objects in the encrypted content according to the user permission of the decryption key, so as to output a corresponding decrypted content.

b. Asymmetric Key Encryption

Different from the symmetric key encryption, the asymmetric key encryption further includes a public key generating procedure and a corresponding decryption procedure. Firstly, the key server 220 selects P₀ from the additive group G₁, and additionally generates a S₀. The S₀ is a master key of the key server 220, and S₀∈Z_{q}*. The key server 220 generates Q₀ according to P₀ and S₀, in which Q₀=S₀*P₀. Then, the key server 220 generates a public key UK by using P₀ and Q₀, in which the public key UK (P₀, Q₀). Furthermore, the key server 220 further sets s₀=H₃^{t}(s₀) for users with the user permission Aₜ.

Subsequently, according to user IDₜ, in which ID={ID₁, ID₂, . . . , IDₜ}, and IDₖ represents users with the user permission Aₖ, and Aₖ<Aₜ∀k, the key server 220 generates Pₜ=H₁(ID₁, ID₂, . . . , IDₜ), Pₜ∈G₁, and respectively sets

$${S}_{t} = {\sum }_{i = 1}^{t} {s}_{i} ⋆ {P}_{i}$$

and Qₜ=sᵢ*P₀ for users with the user permission Aₜ. In other words, this step is used to set a decryption user permission for the content to be encrypted, so that only users with an user permission higher than Aₜ can browse the content. The key server 220 further selects a value r from Z_{q}*, and uses the value r to execute the content encryption procedure, so as to generate encrypted content C, in which C=<rP₁, rP₂, . . . , rPₜ, M⊕H₂(g^{r})>=<U₀, U₂, . . . , Uₜ, V>, and g=e(Q₀,P₁).

When the client 240 sends out a document query request to the document server 210, the key server 220 executes the decryption procedure on the encrypted objects in the encrypted content according to the user permissions of the users, thereby outputting a corresponding decrypted content. Each user executes a decryption procedure according to his/her private key, and the calculation process may be obtained with reference to the following equation.

$$M = V ⊕ {H}_{2} ( \frac{e ( {U}_{0} , {S}_{t} )}{{\prod }_{i = 2}^{t} e ( {Q}_{i - 1} , {U}_{i} )} ) .$$

The hierarchical browsing management method and system for a digital content according to the present invention may be applied in digital documents (txt, word, or e-mail), digital images (JPEG, BMP, or raw), and digital videos. A digital image is taken as an example below for demonstrating this implementation aspect.

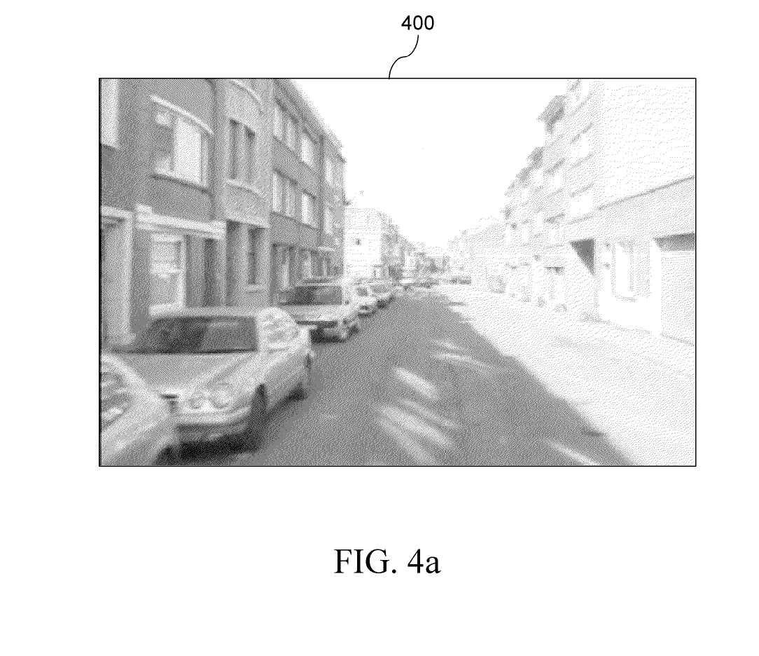

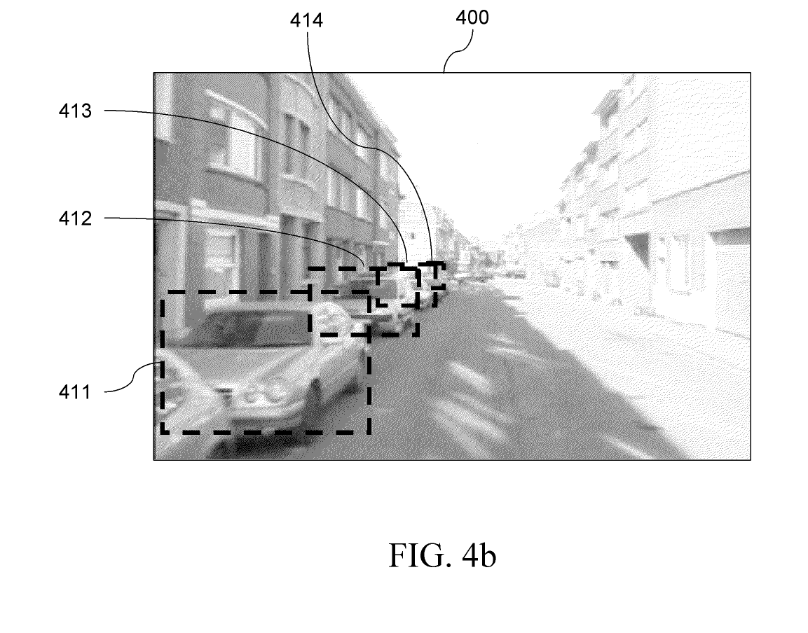

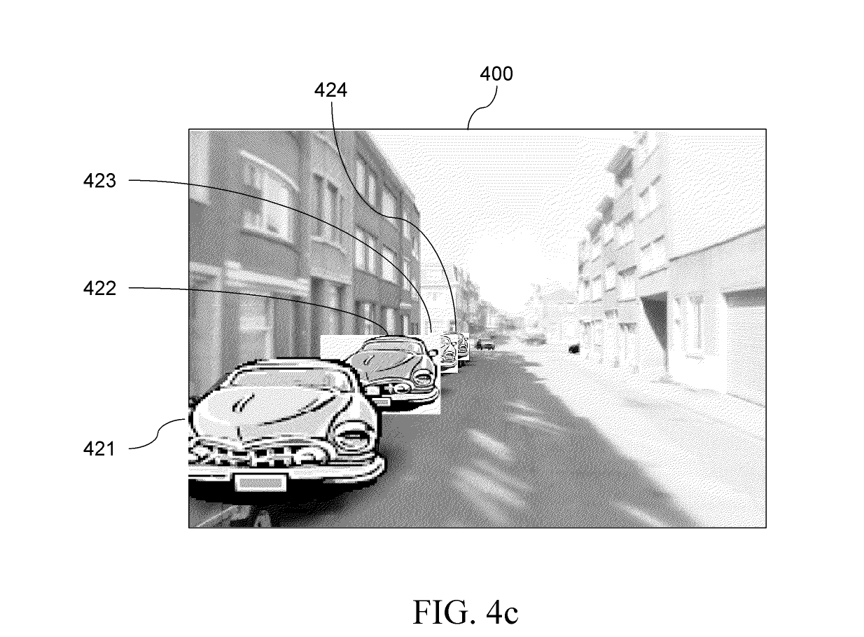

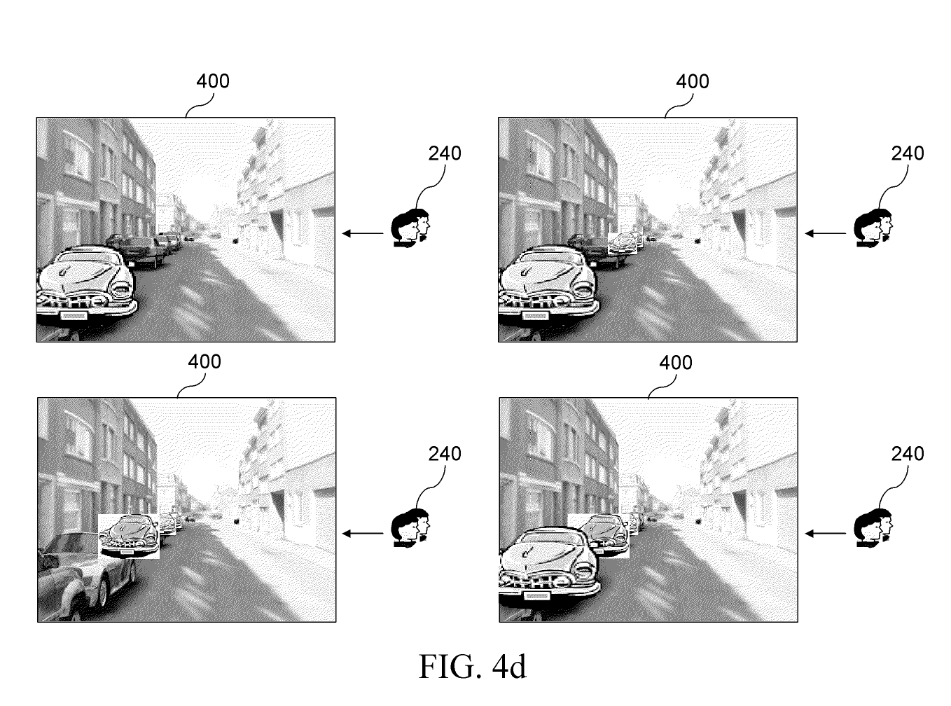

When the implementation aspect is applied in a digital image, each document fetching unit 230 may be a digital camera, a digital video camera, or an IP camera. User permissions of users are divided into k groups. The user permission is represented by Aᵢ, in which the smaller the value i is, the higher the user permission is, and vice versa. In this implementation aspect, a single digital image is taken as an example for demonstration. FIG. 4a is a schematic view of a captured digital image. The document server 210 executes an object fetching procedure to extract content objects in the digital image 400 respectively and store them in the document server 210. FIG. 4b is a schematic view of content objects in the digital image. Referring to FIG. 4b, a first content object 411, a second content object 412, a third content object 413, and a fourth content object 414 are respectively shown, whose positions are represented by white dash line frames.

When a user with the user permission Aₜ intends to send the digital image to users with user permissions higher than Aᵢ, in which t<i<k, the key server 220 executes a content encryption procedure on each content object in the digital image 400 based upon the user permission Aₜ according to a sequence of user permissions, so as to generate corresponding encrypted objects, i.e., generate a first encrypted object 421 for the first content object 411, generate a second encrypted object 422 for the second content object 412, generate a third encrypted object 423 for the third content object 413, and generate a fourth encrypted object 424 for the fourth content object 414.

Then, the document server 210 transmits encrypted objects 421-424 to other users. FIG. 4c is a schematic view of an encrypted digital content. In this implementation aspect, other different image objects are used to replace the encrypted objects. Each user executes a decryption procedure on the received digital image by an exclusive key. After finishing the decryption procedure, the user can only browse the image objects consistent with the user permission, and the image objects inconsistent with the user permission are not displayed in the digital image. FIG. 4d is a schematic view of encrypted objects in the digital content. Furthermore, the image objects inconsistent with the user permission of the user may also be highlighted. Accordingly, the users with different user permissions may browse the image objects corresponding to the user permissions. The hierarchical browsing management of the present invention can avoid the situation that the users in the same group browse the same content in the conventional art. Since each user in the present invention can only browse a part of the content consistent with the authority, insider attackers cannot browse the content that can be browsed by other users.

What is claimed is:

1. A hierarchical browsing management method for a digital content, comprising:
executing an object fetching procedure to fetch a plurality of content objects of a digital content form a server;
executing a content encryption procedure, wherein the server assigns a corresponding user permission user permission to each content object according to an encryption key, so as to generate an encrypted object;
fetching a decryption key by a client; and
executing a decryption procedure on the encrypted object by the client according to the user permission of the decryption key, so as to output a digital content corresponding to the user permission of the decryption key.

2. The hierarchical browsing management method for a digital content according to claim 1, wherein the digital content is a digital document file, a digital image file, or a digital video file.

3. The hierarchical browsing management method for a digital content according to claim 1, wherein the content encryption procedure is a symmetric key encryption or an asymmetric key encryption.

4. The hierarchical browsing management method for a digital content according to claim 3, wherein the symmetric key encryption is data encryption standard (DES), IDEA, RC2, RC4, or other symmetric key encryption manners with the same function.

5. The hierarchical browsing management method for a digital content according to claim 1, wherein the asymmetric key encryption is RSA, digital signature algorithm (DSA), Diffie-Hallman, or other asymmetric key encryption manners with the same function.

6. The hierarchical browsing management method for a digital content according to claim 1, wherein after fetching the digital content, the method further comprises:
recording the encrypted objects, and outputting an encrypted content according to a sequence of user permissions respectively; and
receiving the encrypted content.

7. The hierarchical browsing management method for a digital content according to claim 1, wherein the step of executing the decryption procedure further comprises:
according to the user permission of the decryption key, outputting a corresponding digital content for the encrypted object with an user permission lower than that of the decryption key.

8. A hierarchical browsing management system for a digital content, comprising:
a document server, electrically connected to at least one document fetching unit and at least one client, wherein the document server is used for storing at least one digital document fetched by the document fetching units, and the document server executes an object fetching procedure on the digital documents, so as to fetch a plurality of content objects;
a key server, electrically connected to the document server and the clients, wherein the key server executes a content encryption procedure on the content objects according to encryption keys with different user permissions, generates an encrypted content according to the at least one digital document and the content objects, and stores the encrypted content in the document server; and
a client, electrically connected to the document server and the key server, wherein when the client sends out a document query request to the document server, the key server determines an user permission corresponding to the client, so that the document server submits the corresponding encrypted content to the client according to the user permission of the client, and the client uses a decryption key to execute a decryption procedure on the encrypted content, so as to output a decrypted content corresponding to an user permission of the decryption key.

9. The hierarchical browsing management system for a digital content according to claim 8, wherein the digital content is a digital document file or a digital multimedia file.

10. The hierarchical browsing management system for a digital content according to claim 8, further comprising a plurality of document fetching units for fetching a plurality of digital documents.

11. The hierarchical browsing management system for a digital content according to claim 8, wherein the content encryption procedure is a symmetric key encryption or an asymmetric key encryption.

12. The hierarchical browsing management system for a digital content according to claim 8, wherein the symmetric key encryption is DES, IDEA, RC2, RC4, or other symmetric key encryption manners with the same function.

13. The hierarchical browsing management system for a digital content according to claim 8, wherein the asymmetric key encryption is RSA, DSA, Diffie-Hallman, or other asymmetric key encryption manners with the same function.
